(19) United States
(12) Patent Application Publication
(10) Pub. No.: US 2025/0265868 A1
(43) Pub. Date: Aug. 21, 2025

(54) SYSTEM AND METHOD FOR ROBOT SERVICE

(71) Applicants: Hyundai Motor Company, Seoul (KR); Kia Corporation, Seoul (KR)

(72) Inventors: Kyunghwan Cho, Hwaseong-Si (KR); Jiwon Kim, Hwaseong-Si (KR); Moonsub Jin, Yongin-Si (KR); Keonho Lee, Incheon (KR)

(21) Appl. No.: 18/825,461

(22) Filed: Sep. 5, 2024

(30) Foreign Application Priority Data
Feb. 20, 2024 (KR) 10-2024-0024097

(51) Int. Cl. G06V 40/16; G06V 10/82; G06V 10/94

(52) U.S. Cl. CPC G06V 40/172; G06V 10/82; G06V 10/95

(57) ABSTRACT

A robot service system comprises: a server configured to store a plurality of face recognition models having different degrees of light-weighting; and a robot configured to perform a face recognition function by using any one of the plurality of face recognition models, and identify a user through the face recognition function. The robot may execute the face recognition function by using a face recognition model selected from the plurality of face recognition models based on a hardware environment of the robot.

### CROSS-REFERENCE TO RELATED APPLICATION

This application claims priority to and the benefit of Korean Patent Application No. 10-2024-0024097 filed in the Korean Intellectual Property Office on Feb. 20, 2024, the entire contents of which are incorporated herein by reference.

### TECHNICAL FIELD

The present disclosure relates to a robot service system and a robot service method.

### BACKGROUND

Recently, robots are increasingly used in various places, such as exhibition halls and buildings, to provide services requested by users. In order to increase the satisfaction of service using robots, it is necessary to provide active and immediate service.

To provide active service, robots may be equipped with a face recognition function. The more information about a user is extracted through the face recognition function, the more advantageous to provide active services. However, increasing the complexity of the face recognition function to acquire more information in the robot providing the service with limited resources may make it difficult to provide immediate service.

### SUMMARY

The following summary presents a simplified summary of certain features. The summary is not an extensive overview and is not intended to identify key or critical elements.

Systems, apparatuses, and methods are described for a robot service. A robot service system may comprise: a server configured to store a plurality of face recognition models having different degrees of light-weighting; and a robot. The robot may be configured to: execute a face recognition function using a face recognition model selected, based on hardware environment information of the robot, from the plurality of face recognition models; identify, based on the face recognition function, a user; and provide, based on identifying the user, a service.

A method may comprise: determining hardware environment information of a robot; installing, on the robot, a face recognition model selected, based on the hardware environment information, from a plurality of face recognition models having different degrees of light-weighting; executing, by using the selected face recognition model, a face recognition function; performing, via the face recognition function, a user identification; and providing, based on a result of the user identification, a service to a user.

These and other features and advantages are described in greater detail below.

### BRIEF DESCRIPTION OF THE DRAWINGS

FIG. 1 is a diagram schematically illustrating a robot service system according to an example.

FIG. 2 is a diagram illustrating an example of a lookup table for managing a face recognition model in a robot service system according to the example.

FIG. 3 is a diagram schematically illustrating a robot according to the example.

FIG. 4 is a diagram schematically illustrating a method of installing a face recognition model on each robot 20 in the robot service system according to the example.

FIG. 5 is a diagram schematically illustrating a facial recognition-based user identification method in the robot service system according to the example.

FIG. 6 is a diagram schematically illustrating a method of providing a security service in the robot service system according to the example.

FIG. 7 is a diagram schematically illustrating a method of providing a delivery service in the robot service system according to the example.

FIGS. 8A to 8C are diagrams illustrating examples of a robot providing an item delivery service in the robot service system according to the example.

### DETAILED DESCRIPTION

Hereinafter, examples disclosed the present specification will be described in detail with reference to the accompanying drawings, and the same or similar constituent factor is denoted by the same reference numeral regardless of a reference numeral, and a repeated description thereof will be omitted. Suffixes, “module” and/or “unit” for a constituent element used for the description below are given or mixed in consideration of only easiness of the writing of the specification, and the suffix itself does not have a discriminated meaning or role. Further, in describing the example disclosed in the present disclosure, when it is determined that detailed description relating to well-known functions or configurations may make the subject matter of the example disclosed in the present disclosure unnecessarily ambiguous, the detailed description will be omitted. Further, the accompanying drawings are provided for helping to easily understand examples disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

In the present application, it will be appreciated that terms “including”, “comprising”, and “having” are intended to designate the existence of characteristics, numbers, operations, operations, constituent elements, and components described in the specification or a combination thereof, and do not exclude a possibility of the existence or addition of one or more other characteristics, numbers, operations, operations, constituent elements, and components, or a combination thereof in advance.

In the present application, each of the terms, such as “A or B”, “at least one of A and B”, “at least one of A or B”, “A, B, or C”, “at least one of A, B, and C”, and “at least one of A, B, or C” may include all possible combinations of items listed together in the corresponding one of the phrases.

A program implemented as a set of instructions embodying a control algorithm required to control another configuration may be installed in a configuration for controlling another configuration under a specific control condition among configurations according to an example. The control configuration may process input information and stored information according to an installed program to generate output information. The control configuration may include a non-volatile memory to store a program and a memory to store information.

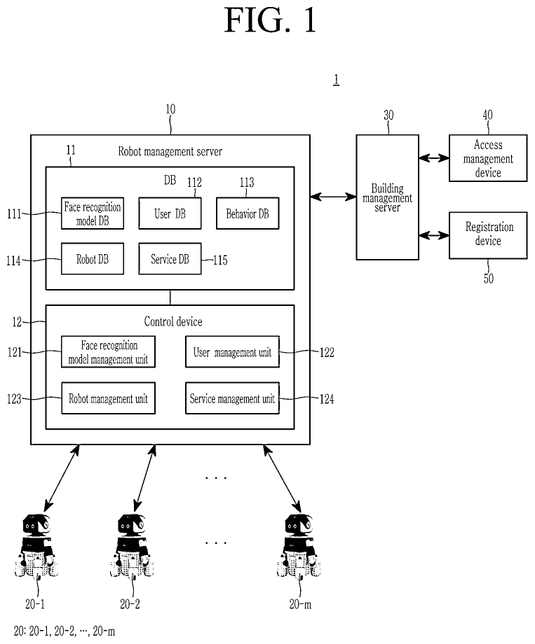

FIG. 1 is a diagram schematically illustrating a robot service system according to an example.

Referring to FIG. 1, a robot service system 1 according to an example is a system for providing services using robots within a building. The robot service system 1 may include a robot management server 10 and a plurality of robots 20:20-1, 20-2, . . . , and 20-m.

The robot service system 1 may include a robot management server 10 and a plurality of robots 20.

The robot management server 10 may communicate (e.g., wirelessly) with the plurality of robots 20, and may assist in providing services by the robots 20. The robot management server 10 may include a database (DB) 11 and a control device 12.

The DB 11 may store various data, information, or the like. The data stored in the DB 11 may be configured to be processed by the robot management server 10. The DB 11 may include a face recognition model DB 111, a user DB 112, a behavior DB 113, a robot DB 114, and/or a service DB 115.

The face recognition model DB 111 may store a plurality of face recognition models that are light-weighted at different levels (e.g., to different degrees). In other words, the face recognition model DB 111 may store installation data of a plurality of face recognition models. The face recognition model DB 111 may store and/or manage a list of the plurality of face recognition models in the form of a lookup table. For each face recognition model, the face recognition model DB 111 may map feature information of the face recognition model—such as the size, throughput, memory usage, and/or performance of the corresponding model—and store the mapped feature information in a lookup table.

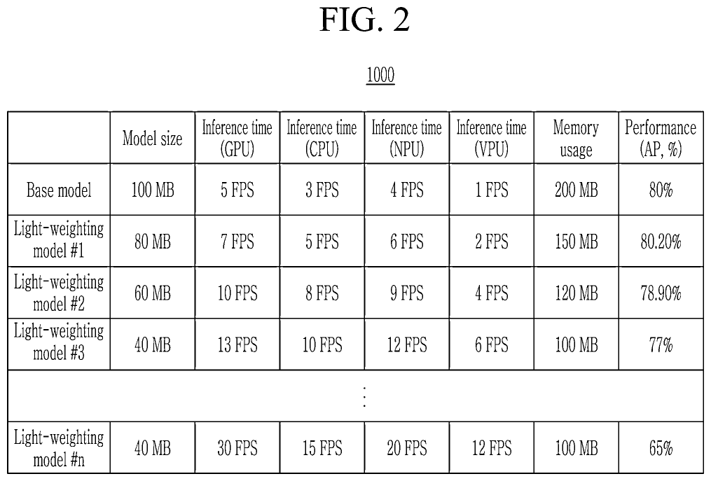

FIG. 2 illustrates an example of a list of face recognition models in the form of an Adaptive Lookup Table (ALT). Referring to FIG. 2, the ALT 1000 may include n face recognition models (a base model, light-weighting model #1, light-weighting model #2, light-weighting model #3, . . . , light-weighting model #n). The ALT 1000 may include size information for each face recognition model. The size information may indicate the size of the installed data for each face recognition model. The ALT 1000 may include processing speed information for each face recognition model. Processing speed information may include the inference time for each face recognition model. Inference time may be defined differently depending on the type of processor executing the face recognition function, such as Graphics Processing Unit (GPU), Central Processing Unit (CPU), Neural Processing Unit (NPU), and/or Visual Processing Unit (VPU). The ALT 1000 may include memory usage information for each face recognition model. The memory usage may represent the memory usage of each face recognition model when running. The ALT 1000 may include performance information for each face recognition model. The performance information may include information about a face recognition rate (face recognition success rate, face recognition accuracy, or the like) of each face recognition model.

Again, referring to FIG. 1, the user DB 112 may store user information for users registered with a building management server 30. The users registered with the building management server 30 may be users who are authorized to enter and/or reside in the corresponding building. The user information may include user's personal information. Personal information may include, for example, a name, affiliation, workplace, and/or phone number of the user. The user information may further include identifying information necessary to identify the user. User identification information may include facial feature information (or facial descriptor) for recognizing the user's face. The user identification information may also include physical information, such as fingerprint information or iris information. User identification information may further include an identification code assigned to the user, such as a Quick Response (QR) code, employee number, or access card number. User information may further include additional attribute information about the user, such as the user's gender and age. The user information may further include the user's access information. The access information may include information about the user's access authorization type (resident, visiting, or the like), access permitted areas, work hours, access permitted time zone, access history, or the like.

The behavior DB 113 may store behavioral information of users entering and exiting the building. The behavior DB 113 may store behavioral information of users registered with the building management server 30. The behavior DB 113 may also store behavioral information of users who are not registered with the building management server 30. The behavior information may include location information of the user. The location information of the user may correspond to a location where the user was last detected by the robot 20 or an access management device 40. The behavior DB 113 may further include movement route information of the user. The movement route information may be information of where the user was detected within the building and the time of detection recorded in the form of a log. The behavior DB 113 may also store schedule information of the user. Schedule information may include schedule type, location, participants, number of participants, schedule start/end times, or the like.

The behavior DB 113 may store service use information for each user. The service use information may include information of the robot service that the user is utilizing or has reserved. The service use information may include the type of robot service that each user is utilizing or has reserved, the progress status of the service (pre-start, in progress, completed, or the like), the location of the service provided, the time of the service provided, the information of the robot 20 performing the service, or the like. For example, if the service that the user has reserved is an item delivery service, the service use information may include location information of an item pickup point or item delivery point, the time of the item pickup, a target to deliver an item, and characteristic information of a delivery target item (weight, type, or the like).

The robot DB 114 may store status information for each robot 20. The status information of the robot 20 may include, for each robot 20, a current power status, a current service progress status (pre-start, in progress, completed, or the like), current location information of the robot 20, information about applications (or functions) currently installed on the robot 20, or the like. The robot DB 114 may also store service provision information for services that each robot 20 is providing or is scheduled to provide. Service provision information may include information about a user receiving the robot service (that is, the service target), the type of service, where the service is provided, and when the service is provided. For example, if the robot 20 is scheduled to provide an item delivery service, the service provision information may include location information of an item pickup point or item delivery point, the time of the item pickup, a service target (that is, the user who delivers the item/the user to whom the item is delivered), and characteristic information of a delivery target item (weight, type, or the like). Also, or alternatively, for example, if the robot 20 is scheduled to provide a schedule (for example, a meeting) guidance service, the service provision information may include information about the schedule start time, schedule end time, schedule performance location, service target (schedule attendee), or the like. The robot DB 114 may also store a service provision history of the robot 20. The service provision history may be information recorded in the form of a log of the user to whom the robot 20 provided the service, the type of service provided to the user, the time the service was provided, whether the service provision failed, or the like

The service DB 115 may store knowledge information required to provide a robot service. The knowledge information may include map data of a building that is needed to provide delivery services, greeting services, or the like via the robot 20. The knowledge information may include question/answer data necessary for the robot 20 to provide a greeting service in response to a question or request from a service target. The service DB 115 also further store building status information for buildings that are providing robot services. The building status information may include door opening and closing information, place usage status (for example, in use, not in use, or reserved), or the like.

The control device 12 may control the overall operation of the robot management server 10. The control device 12 may include a face recognition model management unit 121, a user management unit 122, a robot management unit 123, and a service management unit 124.

The face recognition model management unit 121 may build a face recognition model based on an artificial neural network through deep learning.

The face recognition model management unit 121 may build a plurality of face recognition models. The face recognition model management unit 121 may build a face recognition model (hereinafter referred to as a “base model”) without applying any light-weighting techniques. The face recognition model management unit 121 may build light-weighted face recognition models by applying pruning and/or quantization techniques during the training process based on the base model. The face recognition model management unit 121 may build a plurality of face recognition models with different levels of light-weighting by applying different degrees of pruning and/or quantization.

The face recognition model management unit 121 may build a face recognition model (e.g., each face recognition model) to detect facial feature information (and/or a facial descriptor) from a human face. as the face recognition model may also, or alternatively, detect additional attribute information, such as age and/or gender. If an additional attribute information detection function is added to the face recognition model the size of the face recognition model and the resources required to run the face recognition model are increased, which may decrease the processing speed of the face recognition model. The face recognition model management unit 121 may light-weight the facial feature information detection unit, which may require relatively substantial resources, thereby securing resources to be allocated to additional attribute information detection and preventing recognition speed reduction due to limited resources.

The face recognition model management unit 121 may manage the built plurality of face recognition models by storing the built plurality of face recognition models in the face recognition model DB 111. The face recognition model management unit 121 may generate a lookup table (see the ALT 1000 in FIG. 2) that maps the plurality of face recognition models to feature information corresponding to each face recognition model, and store the lookup table in the face recognition model DB 111.

As illustrated in FIG. 2, the plurality of face recognition models (base model, light-weighting model #1, light-weighting model #2, light-weighting model #3, . . . , light-weighting model #n) may vary in model size, inference time, memory usage, performance, or the like, for example, based on the degree of light-weighting. Multiple light-weighting models may reduce resources (for example, memory) required for execution of functions using the models (e.g., face recognition) and may increase the processing speed (e.g., as the degrees of light-weighting is large), but may reduce face recognition performance.

A same face recognition model may have different recognition speeds depending on the hardware specifications of the robot 20 on which the face recognition model is installed. For example, a low-performance robot and a high-performance robot may have different recognition speeds even if using the same face recognition model. Also, or alternatively, even if robots have the same hardware specifications, the recognition speed of a face recognition model may vary depending on the type and/or number of functions installed on the robot.

Accordingly, the face recognition model management unit 121 may select one of the plurality of face recognition models based on the hardware environment of the robot 20 and provide the selected face recognition model to the robot 20 to assist the robot 20 in obtaining a desired level of recognition performance while providing immediate service. To this end, the face recognition model management unit 121 may receive information about the hardware environment of the robot 20 from the robot 20.

The hardware environment information of the robot 20 may include hardware specification information of the robot 20. The hardware specification information of the robot 20 may include, for example, product specifications of the processor (CPU, GPU, NPU, VPU, or the like), memory and storage size, and power supply method (battery powered, wired connection, or the like). The hardware environment information of the robot 20 may further include performance information that may be indicative of the actual operating performance of the robot 20, such as the type of application installed on the robot 20, the remaining capacity of memory and storage, or the like. The hardware environment information of the robot 20 may also include target performance information of the robot 20 related to the face recognition function. The target performance information of the robot 20 may include information about an inference rate of the face recognition function that is desired to be achieved in the robot 20, minimum performance of the face recognition function that the robot 20 wishes to ensure, or the like.

Based on the hardware environment information received from the robot 20, the face recognition model management unit 121 may retrieve a face recognition model to be applied to the robot 20 from the lookup table (see the ALT 1000 in FIG. 2). The face recognition model management unit 121 may compare the hardware environment information of the robot 20 and the feature information of each face recognition model included in the lookup table to select one of the plurality of face recognition models suitable for the robot 20. The face recognition model management unit 121 may transmit the selected face recognition model to the corresponding robot 20. That is, the face recognition model management unit 121 may transmit installation data enabling the selected face recognition model to be installed to the corresponding robot 20.

The user management unit 122 may manage user information stored in the user DB 112 in association with the building management server 30.

The building management server 30 may receive a request from the registration device 50 for user registration for access management of a corresponding building. If user registration is requested, the building management server 30 may obtain facial recognition information of the user who wishes to register via the registration device 50. If the facial recognition information is obtained via the registration device 50, the building management server 30 may generate user information that includes the facial recognition information. The building management server 30 may also, or alternatively, receive additional information (for example, personal information, additional attribute information, or access information) from the user via the registration device 50 during the user registration process and include the received additional information in the user information. The building management server 30 may transmit the obtained user information to the robot management server 10. The user management unit 122 of the robot management server 10 may store the user information received from the building management server 30 in the user DB 112.

The user management unit 122 may also identify users located within the building in association with the robot 20. The user management unit 122 may receive facial recognition information of a user (hereinafter referred to as a “face recognition target”) from the robot 20. The user management unit 122 may compare the facial recognition information received from the robot 20 with the user information stored in the user DB 112 to verify the identity of the face recognition target.

The user management unit 122 may perform a similarity analysis between the facial feature information of the face recognition target received from the robot 20 and the facial feature information of the users stored in the user DB 112. Here, the user management unit 122 may use a similarity analysis method such as a cosine similarity method. Through the similarity analysis, the user management unit 122 may determine the user whose facial feature information is most similar to the face recognition target among the users registered in the user DB 112. The user management unit 122 may also compare the similarity of the user whose facial feature information is most similar to the face recognition target (the similarity of the facial feature information) with a threshold. If the similarity satisfies (e.g., is equal to or greater than) the threshold, the user management unit 122 may determine that the face recognition target is a user registered in the user DB 112 and is the same as the user with the highest similarity. If the similarity does not satisfy (e.g., is lower than) the threshold, the user management unit 122 may determine that the face recognition target is a user not registered in the user DB 112 and is not the same as the user with the highest similarity. The user management unit 122 may determine that the user identification is successful based on the similarity satisfying (e.g., being equal to or greater than) the threshold. The user management unit 122 may determine that the user identification failed (e.g., the face recognition is not a registered user) based on the similarity is lower than the threshold.

The user management unit 122 may transmit the identification result to the robot 20. The user management unit 122 may inform the robot 20 that the face recognition target is a user registered in the building management server 30 if the user identification is successful (that is, if the same person as the face recognition target is found in the user DB 112). The user management unit 122 may also fetch the user information of the face recognition target from the user DB 112 and/or transmit the user information to the robot 20. If the user management unit 122 fails to identify the user (that is, if the same person as the face recognition target is not found in the user DB 112), the user management unit 122 may inform the robot that the face recognition target is not a registered user of the building management server 30.

The face recognition information received from the robot 20 may include additional attribute information, such as gender and/or age. Based on the additional attribute information, the user management unit 122 may determine only some of the users registered in the user DB 112 as a candidate group for the similarity analysis. That is, the user management unit 122 may determine that, based on the received additional attribute information, users who are of the same gender or similar age as the face recognition target among the users registered in the user DB 112 as a candidate group. Further, the user management unit 122 may perform the similarity analysis with the face recognition target only on the users selected as the candidate group to search for users who match the face recognition target. Performing the similarity analysis on only some of the users registered in the user DB 112 (e.g., by selecting the candidate group using additional attribute information) may reduce the time spent on similarity analysis and/or imprive recognition performance.

If the user management unit 122 succeeds in identifying the user, the user management unit 122 may update the corresponding user's behavior information (location information, movement route information, or the like) in the behavior DB 113 based on the location information received from the robot 20.

If the user management unit 122 fails to identify the user (that is, if the user whose face is recognized by the robot 20 is identified as a user not registered in the building management server 30), the user management unit 122 may instruct the robot 20 that detected the user to surveil the user. The robot 20 receiving the surveilling instruction may collect surveillance information, such as image or location information of the user to be surveilled, and transmit the collected surveillance information to the user management unit 122 of the robot management server 10. If the user management unit 122 receives the surveillance information of the unregistered user from the robot 20, the user management unit 122 may store and manage the surveillance information in the user DB 112 or the behavior DB 113. Additionally, the user management unit 122 may transmit the surveillance information received from the robot 20 to the building's security system (not illustrated) or security personnel.

The user management unit 122 may manage the user's behavior information stored in the behavior DB 113 in association with the building management server 30. The building management server 30 may detect a user's access to a building or a specific place within the building through the access management device 40, and generate user behavior information (location information, movement route information, or the like) based on the access detection results. The access management device 40 may detect a user's access to a building or a specific place within a building by using various user identification methods, such as facial recognition. For example, the access management device 40 may detect a user's access based on facial recognition. The access management device 40 may perform facial recognition by using one of the plurality of face recognition models stored in the face recognition model DB 111. Also, or alternatively, the access management device 40 may detect the access of a user by using a physical information-based method, such as a fingerprint and an iris, an identification code-based method, such as a quick-response (QR) code, a communication authentication method with a user terminal (not illustrated), or the like. The building management server 30 may transmit the user behavior information, detected via the access management device 40, to the robot management server 10. The user management unit 122 of the robot management server 10 may store the received behavior information in the behavior DB 113. The behavior DB 113 built as described above may be utilized for purposes such as security management, time and/or attendance management, marketing, or the like.

The robot management unit 123 may manage the status of the robot 20, and/or may manage the provision of services by the robot 20.

The robot management unit 123 may continuously collect status information of the robot 20. The status information of the robot 20 may include, for example, a current power state of the robot 20, a current service progress status of the robot 20 (pre-start, in progress, completed, or the like), current location information of the robot 20, and information of applications (or functions) currently installed on the robot 20. The robot management unit 123 may store the collected status information of the robot 20 in the robot DB 114.

The robot management unit 123 may also, or alternatively, collect service provision information of the robot 20 by monitoring the service performance status of the robot 20. The service provision information of the robot 20 may include information about the user to whom the robot service is provided (that is, the service target), the type of service, the location of the service provision, the time of the service provision, or the like. The robot management unit 123 may store the collected service provision information of the robot 20 in the robot DB 114.

The service management unit 124 may manage and support the service performance of the robot 20.

Based on a robot service being requested (e.g., a request for the service being received by the service management unit 124), the service management unit 124 may assign the corresponding service to one of the plurality of robots 20. If a robot service is requested to be provided, the service management unit 124 may determine which robot 20 to provide the service based on behavioral information and status information of each robot 20 stored in the robot DB 114. Based on the robot 20 to provide the service being determined, the service management unit 124 may provide additional information related to the service to the robot 20 so that the robot 20 performs the service. For example, in the case of an item delivery service, the service management unit 124 may select, among the robots 20 equipped with item carrying capabilities, the robot 20 that is not performing a service at the current time or the delivery requested time and is closest to the item pickup point as the robot 20 to provide the item delivery service. The robot management unit 123 may then transmit to the selected robot 20 the location information of the item pickup point or item delivery point, the item pickup time, the service target (item delivery target), the characteristic information of the item to be delivered (weight, type, or the like), the item delivery route, or the like.

If the service management unit 124 determines that the user whose face is recognized by the robot 20 is an unregistered user, the service management unit 124 may instruct the robot 20 to provide greeting services to the user. The robot 20 receiving the instruction to guide may guide the user to the user's destination or to an information desk.

The service management unit 124 may also instruct the robot 20 to provide guidance services for a scheduled appointment or service reservation history based on a scheduled appointment or service reservation history for the user whose face is recognized by the robot 20. For example, if an item delivery service is in progress or is scheduled for the user whose face is recognized by the robot 20, the service management unit 124 may instruct the robot 20 to output guidance information about the item delivery service. Also, or alternatively, for example, based on existence of a scheduled appointment in which the user whose face is recognized by the robot 20 needs to participate in, the service management unit 124 may instruct the robot 20 to notify the user of the corresponding scheduled appointment.

The control device 12 of the robot management server 10 may include at least one processor. A processor may refer to a data processing device, such as a microprocessor, central processing unit (CPU), processor core, multiprocessor, application-specific integrated circuit (ASIC), or field programmable gate array (FPGA), having physically structured circuitry to perform functions expressed as code or instructions contained in a program (for example, the functions of the face recognition model management unit 121, user management unit 122, robot management unit 123, and service management unit 124).

The robot 20 may communicate (e.g., wirelessly) with the robot management server 10, and/or may identify users and/or provide services to the users in association with the robot management server 10.

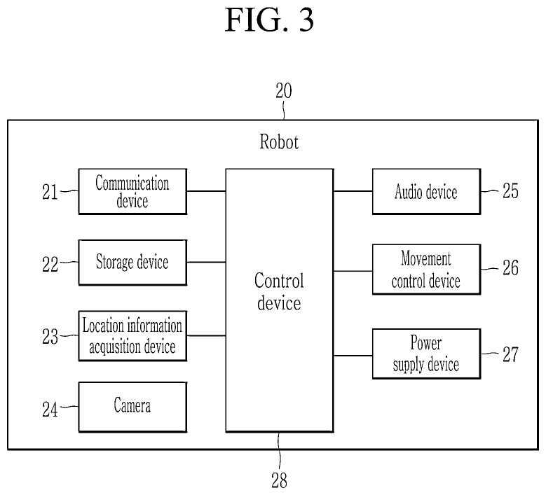

Referring to FIG. 3, each robot 20 may include a communication device 21, a storage device 22, a location information acquisition device 23, a camera 24, an audio device 25, a movement control device 26, a power supply device 27, and a control device 28.

The communication device 21 may transmit and/or receive data between the robot 20 and an external device (for example, the robot management server 10) via a wireless communication scheme.

The storage device 22 may store various data, information, or the like processed by the robot 20. The storage device 22 may store hardware environment information of the robot 20. The hardware environment information of the robot 20 may include hardware specification information of the robot 20. The hardware specification information of the robot 20 may include, for example, product specifications of the processor (CPU, GPU, NPU, VPU, or the like), memory and storage size, and power supply method (battery powered, wired connection, or the like). The hardware environment information of the robot 20 may also, or alternatively, include performance information that may be indicative of the actual driving performance of the robot 20, such as the type of applications installed on the robot 20, the remaining capacity of the storage device 22 (memory/storage remaining capacity), or the like. The hardware environment information of the robot 20 may also include target performance information of the robot 20. The target performance information of the robot 20 may include information about an inference speed that the robot 20 wants to achieve, minimum performance that the robot 20 wants to ensure, or the like. The storage device 22 may store map data around the location where the robot 20 is located. That is, the storage device 22 may store map data inside the building where the robot 20 is located. The storage device 22 may also store speech data for the robot 20 to speak.

The storage device 22 may also store programs for operation of the control device 28. For example, the storage device 22 may store programs for performing face recognition functions, route navigation functions, speech functions, or the like on the control device 28.

The location information acquisition device 23 may detect location information of the robot 20. The location information acquisition device 23 may include at least one sensor for acquiring location information, such as a global position system (GPS) sensor or a barometric pressure/altitude sensor, and may acquire location information of the robot 20 based on the information acquired through these sensors.

The camera 24 may acquire image information by photographing the surroundings of the robot 20. For example, the camera 24 may acquire an image of a user by photographing a user who is a face recognition target.

The audio device 25 may receive an audio signal input and/or output an audio signal. For example, the audio device 25 may include a microphone or the like, and receive a speech signal from the user through the microphone or the like

Also, for example, the audio device 25 may include a speaker or the like, and may output various acoustic signals, such as voice signals.

The movement control device 26 may control a movement (posture, movement, or the like) of a body of the robot 20. The movement control device 26 may receive a control signal from the control device 28 described later, and may control the movement of the body of the robot 20 according to the received control signal.

The power supply device 27 includes a battery (not illustrated), and the battery may supply power required for operation of the robot 20. The power supply device 27 may control charging and discharging of the battery. The power supply device 27 may also monitor the status of the battery to detect the current power status of the robot 20. The control device 28 may control the overall operation of the robot 20.

The control device 28 may receive the face recognition model from the robot management server 10 and install the face recognition model on the robot 20. The control device 28 may transmit hardware environment information of the robot 20 to the robot management server 10 for installation of the face recognition model. The control device 28 may also detect performance information indicative of the actual driving performance of the robot 20 and include the detected performance information in the hardware environment information and transmit the performance information and the hardware environment information. The control device 28 may set target performance information of the robot 20 based on a control input input from an external source and transmit and include the set target performance information in the hardware environment information and transmit the target performance information and the hardware environment information. The control device 28 may transmit the hardware environment information of the robot 20 to the robot management server 10 upon initial startup, upon power-on, upon restart, upon receipt of an update request from a user, or periodically.

Upon receiving the hardware environment information from the robot 20, the robot management server 10 may determine a face recognition model suitable for the hardware environment information of the robot 20 from among the plurality of face recognition models. If the robot management server 10 determines a face recognition model suitable for the hardware environment information of the robot 20, the robot management server 10 may transmit installation data of the corresponding face recognition model to the robot 20.

Based on the control device 28 receiving the installation data of the face recognition model from the robot management server 10, the control device 28 may install or update the face recognition model on the robot 20 by using the received installation data. Here, installing the face recognition model on the robot 20 means installing an application or program that performs the face recognition function on the robot 20.

Based on a facial recognition request being made/received, the control device 28 may perform facial recognition of the user by using the installed face recognition model. Based on the facial recognition request being made/received, the control device 28 may activate the camera 24 to acquire image information of the user that is the face recognition target. Further, the control device 28 may detect facial feature information (facial descriptor) of the face recognition target from the image captured by the camera 24 by using the face recognition model. Based on the facial feature information being detected, the control device 28 may proceed with user identification of the face recognition target in association with the robot management server 10 based on the detected facial feature information.

The operation of identifying a user based on the face recognition information detected by the robot 20 may be performed by the robot management server 10. In this case, the control device 28 may transmit the face recognition information including facial feature information detected from the face recognition target to the robot management server 10. Upon receiving the face recognition information from the robot 20, the robot management server 10 may search for a user matching the face recognition target among the users registered with the robot management server 10 through the similarity analysis as described above. Further, based on the user matching the face recognition target being found from among the pre-registered users, the robot management server 10 may transmit an identification result including the user information of the corresponding user to the robot 20. Based on the user matching the face recognition target not being found from among the pre-registered users, the robot management server 10 may also notify the robot 20 that the identification of the face recognition target has failed.

The control device 28 may also, or alternatively, detect additional attribute information, such as gender and age, from the image obtained by photographing the face recognition target. The control device 28 may include the additional attribute information in the facial recognition information and transmit the additional attribute information and the facial recognition information to the robot management server 10 to enable quick identification of the face recognition target. The control device 28 may detect the location information of the robot 20 at the time of the user image photographing or face recognition via the location information acquisition device 23, and/or may acquire the location information of the user based on the detected location information. The control device 28 may include the obtained user location information in the face recognition information and/or transmit the user location information and/or the face recognition information to the robot management server 10.

The operation of identifying a user based on the face recognition information detected by the robot 20 may be performed by the control device 28 of the robot 20. In this case, based on the facial feature information being detected, the control device 28 may directly perform the operation of analyzing the similarity between the detected facial feature information and the facial feature information stored in the user DB 112 of the robot management server 10. The operation of identifying the face recognition target by the control device 28 through the similarity analysis may proceed in the same way as the method of identifying the face recognition target through the similarity analysis in the user management unit 122 of the robot management server 10.

The control device 28 may control the operation of the robot 20 according to the identification result (of identifying the user via the facial recognition) to provide active services to the user whose face has been recognized. For example, the control device 28 may provide services, such as managing the user's behavioral data, guiding, delivering, or guiding, to the user based on the result of the user identification. If the face recognition target is an unregistered user, the control device 28 may provide a service of guiding the user to a user's destination or information desk. If the face recognition target is a pre-registered user and a pre-registered schedule or service reservation history exists on the robot management server 10 for the pre-registered user, the control device 28 may provide guidance services to the user (e.g., about the schedule and/or service reservation history). If the face recognition target is a pre-registered user and there exists an item delivery service that is in progress or is scheduled for the pre-registered user, the control device 28 may instruct the robot 20 to output guidance information about the item delivery service. If the robot 20 is in the process of delivering an item to a user and the facially recognized user is identified as the user to whom the item is to be delivered, the control device 28 may deliver the item that is being delivered to the user.

The control device 28 may continuously collect status information related to the operational status of the robot 20. The status information of the robot 20 may include, for example, a current power state of the robot 20, a current service progress status of the robot 20 (pre-start, in progress, completed, or the like), current location information of the robot 20, and information of applications (or functions) currently installed on the robot 20. The control device 28 may transmit the collected status information of the robot 20 to the robot management server 10. The robot management server 10 receiving the status information may update the information stored in the DB 11 based on the received information, or may assist in providing the services to the robot 20.

The control device 28 of each robot 20 may include at least one processor for performing the aforementioned functions.

In accordance with the foregoing, the robot 20 may be equipped with the face recognition function and may provide active robot services by providing personalized services to users identified by using the face recognition function. Furthermore, by selecting the complexity of the face recognition model equipped on the robot 20 to match the actual driving performance of the robot 20 as well as the hardware specifications of the robot 20, immediate service provision is possible within the limited resources of the robot 20.

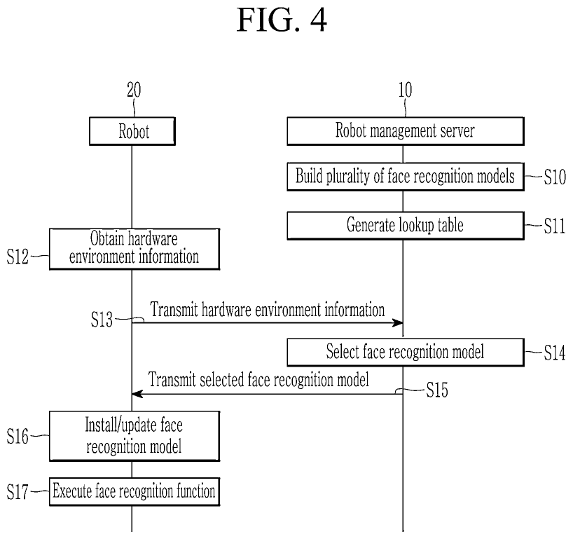

Hereinafter, a method of providing immediate and active robot services in the robot service system 1 will be described with reference to FIGS. 4 to 7.

FIG. 4 is a diagram schematically illustrating a method of installing a face recognition model on each robot 20 in the robot service system according to an example.

Referring to FIG. 4, the robot management server 10 may build a plurality of face recognition models (S10).

In operation S10, the robot management server 10 may build a face recognition model based on an artificial neural network through deep learning. In operation S10, the robot management server 10 may build a plurality of face recognition models with different levels of light-weighting. The robot management server 10 may build a plurality of face recognition models with different light-weighting levels by applying different degrees of pruning and quantization during the training process of each face recognition model. The robot management server 10 may build the plurality of face recognition models to include a base model with no light-weighting applied. In operation S10, the robot management server 10 may build the face recognition models to detect feature information about a human face as well as additional attribute information, such as age and gender, at the time of building each face recognition model. In light-weighting the face recognition model, the robot management server 10 may light-weight the facial descriptor detection part, which requires a relatively large amount of resources, to secure resources allocated to detect additional attribute information.

The robot management server 10 may generate a lookup table (see the ALT 1000 in FIG. 2) that maps the plurality of built face recognition models to the feature information corresponding to each face recognition model (S11).

In operation S11, the robot management server 10 may generate a lookup table by mapping, for each face recognition model, the model size, inference time, memory usage, recognition performance, or the like

The robot 20 may obtain its hardware environment information (S132).

In operation S12, the robot 20 may acquire its hardware specification information as hardware environment information. The hardware specification information of the robot 20 may include, for example, product specifications of the processor (CPU, GPU, NPU, VPU, or the like), memory and storage size, and power supply method (battery powered, wired connection, or the like). In operation S12, the robot 20 may also obtain performance information that may indicate the actual driving performance of the robot 20, such as the type of applications installed on the robot 20, the remaining capacity of the memory and the storage, or the like, as hardware environment information of the robot 20. In operation S12, the robot 20 may obtain target performance information, such as an inference speed to be achieved and minimum performance to be guaranteed by the robot 20, as hardware environment information.

The robot 20 may transmit its hardware environment information obtained in operation S12 to the robot management server 10 (S13).

The robot management server 10 receiving the hardware environment information may select a face recognition model to be provided to the robot 20 from among the plurality of face recognition models registered in the lookup table based on the received hardware environment information of the robot 20 (S14). Further, the robot management server 10 may transmit the selected face recognition model to the robot 20 (S15). In other words, the robot management server 10 may transmit installation data of the selected face recognition model to the robot 20.

After/based on receiving the face recognition model from the robot management server 10, the robot 20 may install the face recognition model on the robot 20 or update the face recognition model installed on the robot 20 by using the received face recognition model (S16). That is, the robot 20 may install an application or program on the robot 20 that performs the face recognition function, or to update an application or program for facial recognition installed on the robot 20 by using the received face recognition model. Thereafter, the robot 20 may execute the face recognition function by using the newly installed or updated face recognition model (S17).

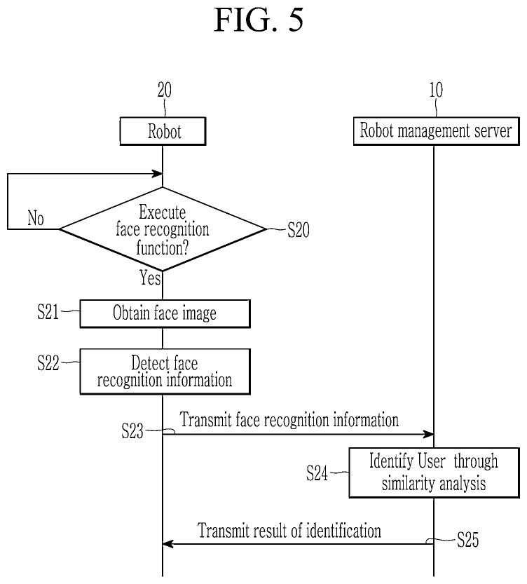

FIG. 5 is a diagram schematically illustrating a facial recognition-based user identification method in the robot service system according to the example.

Referring to FIG. 5, based on the face recognition function being executed (S20), the robot 20 may acquire a facial image of a face recognition target via the camera 24 (S21). The robot 20 may also detect facial recognition information from the photographed facial image (S22).

In operation S22, the robot 20 may detect facial feature information (or facial descriptor) from the user image. The robot 20 may also detect additional attribute information from the user image, such as gender and age.

The robot 20 may transmit the facial recognition information detected in operation S22 to the robot management server 10 for user identification (S23). The robot management server 10 receiving the facial recognition information may identify the corresponding user among the registered users through similarity analysis (S24).

In operation S24, the robot management server 10 may perform a similarity analysis between the facial feature information included in the facial recognition information and the facial feature information of the pre-registered users. The robot management server 10 may determine, through the similarity analysis, a user having the highest similarity to the facial recognition information of the face recognition target among the pre-registered users. Further, based on the similarity of the user with the highest similarity satisfying (e.g., being equal to or greater than) the threshold, the robot management server 10 may finally determine that the corresponding user is the same as the face recognition target. On the other hand, based on the similarity of the user with the highest similarity not satisfying (e.g., being lower than) the threshold, the robot management server 10 may determine that the user identification is failed.

In operation S24, the robot management server 10 may also select a candidate group for the similarity analysis from among the pre-registered users based on the additional attribute information included in the facial recognition information. For example, the robot management server 10 may determine users of the same gender or similar age as the face recognition target among the pre-registered users as a candidate group based on the received additional attribute information. Based on the candidate group being selected, the robot management server 10 may proceed with user identification by performing the similarity analysis of facial feature information only on the users selected as the candidate group.

The robot management server 10 may transmit the identification result (from the identification task) to the robot 20 (S25).

In operation S25, the robot management server 10 may transmit the identification result indicating the successful identification to the robot 20 based on the user identification being successful (that is, if the same person as the recognition target is found/matched from among the registered users). Also, or alternatively, the robot management server 10 may further transmit user information of the user identified as the same person as the face recognition target to the robot 20. On the other hand, if the user identification fails (that is, if the recognition target is not found/matched among the registered users), the robot management server 10 may transmit the identification result to the robot 20 indicating the identification failure (or unsuccess).

FIG. 5 illustrates an example in which the operation of specifying a user based on facial feature information detected from a face recognition target is performed by the robot management server 10, and the robot 20 receives the identification result from the robot management server 10. However, in other examples, the operation of specifying the user through the similarity analysis may also be performed by the robot 20. In this case, based on the facial feature information being detected, the robot 20 may directly access the user DB 112 of the robot management server 10 and perform the similarity analysis between the facial feature information of the face recognition target and the facial feature information of the users registered in the user DB 112. Then, the robot 20 may specify a person identical to the face recognition target among the users registered in the user DB 112 based on the result of the similarity analysis.

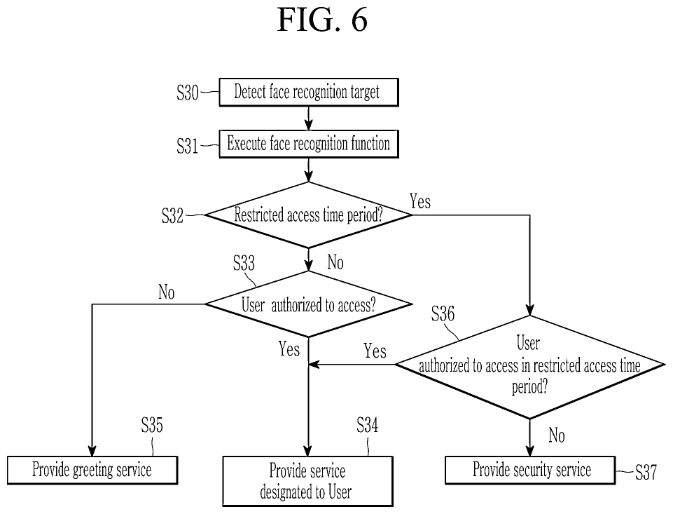

FIG. 6 is a diagram schematically illustrating a method of providing a security service in the robot service system according to the example.

Referring to FIG. 6, based on the face recognition target being detected (S30), the robot 20 proceeds with the user identification process (see FIG. 5) by executing the face recognition function (S31).

The robot 20 determines whether the current time belongs to a restricted access time period (for example, nighttime) based on access to the building being restricted (S32). If the current time does not belong to the restricted access time period, the robot 20 may be in association with/communicate with the robot management server and check whether the face recognition target is a user authorized to access the corresponding building (S33).

In operation S33, if the face recognition target is identified as a user registered in the user DB 112 of the robot management server 10 (e.g., in the process of user identification via the face recognition) the robot 20 may determine that the face recognition target is a user authorized to access the corresponding building.

In operation S33, if the face recognition target is the user authorized to access, the robot 20 may be in association with/communicate with the robot management server 10 and provide a designated robot service (for example, delivering an item, making a reservation, or informing of service progress) to the user (S34).

In operation S33, based on the face recognition target not being a user authorized to access, the robot 20 may provide a greeting service that directs the face recognition target to a destination or information desk requested by the face recognition target (S35).

In operation S32, if it is determined that the current time belongs to the restricted access time period, the robot 20 may be in association with the robot management server 10 to check whether the face recognition target is a user authorized to access the building corresponding to the restricted access time period (S36).

If it is identified that the face recognition target is the user registered in the user DB 112 of the robot management server 10 in the process of identifying the user through facial recognition in operation S36, the robot 20 may check whether the user is a user authorized to access even during the restricted access time period based on the user information stored in the user DB 112 (for example, residency status, or access authorization time). If the face recognition target is not identified as a user registered in the user DB 112 of the robot management server 10 in the process of user identification through the face recognition in operation S36, the robot 20 may determine that the face recognition target is not a user authorized to access.

If it is determined that the face recognition target is a user authorized to access even during the restricted access time period in operation S36, the robot 20 may be in association with the robot management server 10 and provide the robot service designated to the corresponding user (S34).

If it is not determined that the face recognition target is a user authorized to access even during the restricted access time period in operation S36, the robot 20 may provide security services (S37).

In operation S37, the robot 20 may output a message to the face recognition target informing the face recognition target of the restricted access. In operation S37, the robot 20 may also transmit a message to the building management server 30, a security system, a security personnel, or the like to alert the building management server 30, the security system, the security personnel, or the like of the restricted user's access.

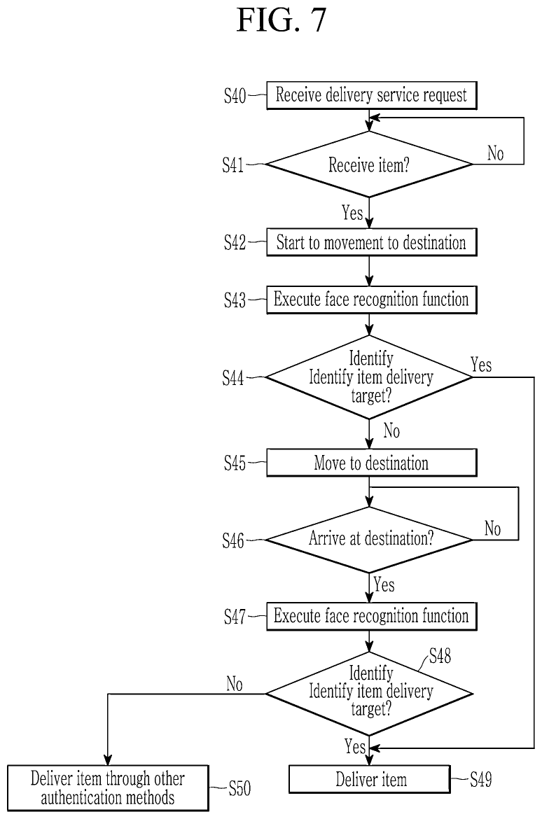

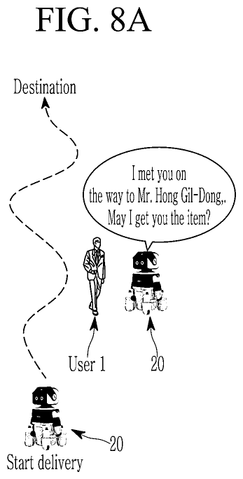

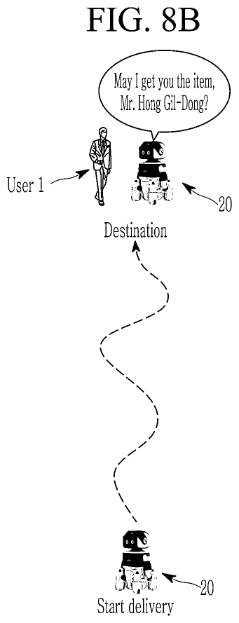

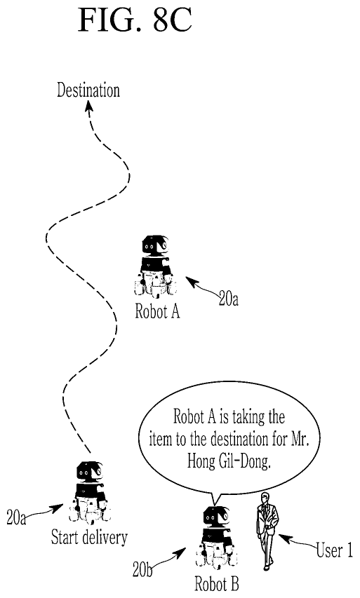

FIG. 7 is a diagram schematically illustrating a method of providing a delivery service in the robot service system according to the example. FIGS. 8A to 8C are diagrams illustrating examples of a robot 20 providing an item delivery service according to the example.

Referring to FIG. 7, the robot 20 may receive a delivery service request (S40).

In operation S40, the robot 20 may also receive a delivery service request from the robot management server 10. In operation S40, the robot 20 may also receive a control input from a user requesting a delivery service.

In operation S40, if the robot 20 receives the delivery service request, the robot 20 may also receive service use information including location information of an item pickup point or item delivery point, the time of the item pickup, a target to deliver an item, and characteristic information of a delivery target item (weight, type, or the like).

Then, if the robot 20 acquires the item that is a delivery target (S41), the robot 20 may start movement to a delivery destination based on the service use information (S42).

During the movement to the destination, the robot 20 may continuously execute the face recognition function (S43) to continuously check whether the item delivery target is identified (S44).

In operation S44, if the item delivery target is identified through the facial recognition, the robot 20 may deliver the item that is being delivered to the identified item delivery target (S49). Referring to FIG. 8A, the robot 20 may encounter a user (user 1) who is an item delivery target while moving to the destination. Therefore, the robot 20 may continue to execute the face recognition function while moving to the destination, and if the robot 20 meets the item delivery target before arriving at the destination, the robot 20 may immediately deliver the item that is being delivered to the item delivery target (user 1) without moving to the destination.

If the face recognition target encountered while moving to the destination is not the item delivery target, the robot 20 may continue moving to the destination (S45).

If the robot 20 arrives at the destination without delivering the item (S46), the robot 20 may execute the face recognition function (S47) to check whether the item delivery target is identified at the destination (S48).

In operation S48, if the item delivery target is identified at the destination (e.g., via the facial recognition), the robot 20 may deliver the item that is being delivered to the identified item delivery target (S49). Referring to FIG. 8B, the robot 20 may execute the face recognition function when arriving at the destination to detect the user (user 1) who is the item delivery target. If the robot 20 detects the item delivery target (user 1) at the destination through the facial recognition, the robot 20 may directly deliver the item that is being delivered to the item delivery target (user 1) without any other additional procedures.

If the item delivery target is not identified by the face recognition method in operation S48, the robot 20 may authenticate the item delivery target through various authentication methods, such as fingerprint recognition, voice recognition, or QR code recognition, and deliver the item (S50).

Also, or alternatively, if the item delivery target is not at the destination, the robot service system 1 may induce the item delivery target to move to the destination or assist the robot 20 that is delivering the item to move to the item delivery target through the connection with the robots 20.

FIG. 8C illustrates an example where an item delivery target is at a location other than a destination and the robot service system requests the item delivery target to move to the destination through another robot. Referring to FIG. 8C, in a situation where the robot 20a is moving to deliver an item to the item delivery target (user 1), another robot 20b may also detect an item delivery target (user 1) at a location other than the destination through the facial recognition. In this case, the robot 20b may inform the item delivery target (user 1) that another robot is currently moving to the destination to deliver the item and induce the item delivery target (user 1) to move to the destination.

The present disclosure attempts to provide a robot service system and a robot service method that are capable of supporting active and immediate service provision by a robot.

An example of the present disclosure provides a robot service system comprising: a server configured to store a plurality of face recognition models having different degrees of light-weighting; and a robot configured to perform a face recognition function by using any one of the plurality of face recognition models, and identify a user through the face recognition function.

The robot may be further configured to execute the face recognition function by using a face recognition model selected from the plurality of face recognition models based on a hardware environment of the robot.

The robot may be further configured to transmit hardware environment information of the robot to the server, receive the selected face recognition model from the server, and install the selected face recognition model on the robot.

The server may be further configured to select one of the plurality of face recognition models based on the hardware environment information, and transmit the selected face recognition model to the robot.

The hardware environment information may include hardware specification information of the robot. The hardware environment information may include at least one of the type of application installed on the robot and the remaining capacity of a memory or a storage of the robot, and further include performance information indicative of actual driving performance of the robot. The hardware environment information may further include target performance information associated with the face recognition function.

The server may be further configured to store a lookup table in which the plurality of face recognition models matches to feature information of each of the plurality of face recognition models, and select a face recognition model to be provided to the robot from among the plurality of face recognition models based on the hardware environment information and the feature information. The feature information may include at least one of a size, throughput, memory usage, and performance of the corresponding face recognition model.

The plurality of face recognition models may be artificial neural network-based models built through deep learning. At least some of the plurality of face recognition models may be light-weighted by pruning and quantization techniques during a training process.

When the face recognition function is executed, the robot may be further configured to detect facial feature information from an image obtained by photographing a face recognition target, and verify an identity of the face recognition target based on the facial feature information.

The robot may be further configured to transmit the facial feature information of the face recognition target to the server. The server may be further configured to store user information including facial feature information for each of a plurality of pre-registered users, and verify the identity of the face recognition target by a similarity analysis between the facial feature information of each of the plurality of pre-registered users and the facial feature information of the face recognition target when the facial feature information of the face recognition target is received from the robot.

The robot may be further configured to detect additional attribute information including age or gender from the image, and transmit facial recognition information including the facial feature information and the additional attribute information to the server. The server may be further configured to select a candidate group from the plurality of pre-registered users for a similarity analysis based on the additional attribute information, and verify an identity of the face recognition target by the similarity analysis between facial feature information of the candidate group and the facial feature information of the face recognition target.

The server may be further configured to collect location information of the robot and manage behavioral information of a user recognized by the face recognition function in the robot based on the location information.

When the user recognized by the face recognition function is an unregistered user, the robot may be further configured to provide a greeting service to guide the unregistered user or a surveillance service to surveil the unregistered user.

When the user is pre-registered on the server, the robot may be further configured to provide a service to the user based on user information of the user.

Another example of the present disclosure provides a robot service method of a robot, the robot service method comprising: obtaining hardware environment information of the robot; installing on the robot a face recognition model selected according to the hardware environment information from among a plurality of face recognition models having different degrees of light-weighting; executing a face recognition function by using the selected face recognition model; performing user identification by using the face recognition function; and providing a service to a user based on a result of the user identification.

The robot service method may further include: transmitting the hardware environment information to a server managing the plurality of face recognition models; and receiving the selected face recognition model from the server.

In the robot service system, the hardware environment information may include at least one of hardware specification information, performance information, and target performance information related to the face recognition function of the robot.

In the robot service method, the plurality of face recognition models may be artificial neural network-based models built through deep learning, and at least some of the plurality of face recognition models may be light-weighted by pruning and quantization techniques during a training process.

The performing of the user identification may include: acquiring a face image by photographing a face recognition target; detecting facial feature information from the facial image; and performing the user identification based on user information of a plurality of pre-registered users and the facial feature information.

The user information may include facial feature information of the corresponding user. The performing of the user identification may include: performing a similarity analysis between facial feature information of the face recognition target and facial feature information of each of the plurality of pre-registered users; determining, based on a result of the similarity analysis, a user having the highest similarity to the face recognition target among the plurality of pre-registered users; and when the similarity of the user having the highest similarity is equal to or greater than a threshold, determining that the face recognition target is the user having the highest similarity.

The performing of the user identification may include when the similarity of the user having the highest similarity is lower than the threshold, determining the face recognition target as an unregistered user.

According to the present disclosure, it is possible to support active and immediate service of robots.

While the present description provides what is presently considered to be practical examples, it is to be understood that the description is not limited to the disclosed examples.

What is claimed is:

1. A robot service system comprising:
a server configured to store a plurality of face recognition models having different degrees of light-weighting; and
a robot configured to:
execute a face recognition function using a face recognition model selected, based on hardware environment information of the robot, from the plurality of face recognition models;
identify, based on the face recognition function, a user; and
provide, based on identifying the user, a service.

2. The robot service system of claim 1, wherein:
the robot is further configured to:
transmit, to the server, the hardware environment information of the robot;
receive the selected face recognition model from the server; and
install, on the robot, the selected face recognition model; and
the server is further configured to:
select, based on the hardware environment information, the selected face recognition model from the plurality of face recognition models; and
transmit, to the robot, the selected face recognition model.

3. The robot service system of claim 1, wherein:
the hardware environment information comprises hardware specification information of the robot.

4. The robot service system of claim 1, wherein:
the hardware environment information comprises at least one of:
a type of application installed on the robot;
a remaining capacity of a memory or a storage of the robot; or
performance information indicative of actual driving performance of the robot.

5. The robot service system of claim 1, wherein:
the hardware environment information comprises target performance information associated with the face recognition function.

6. The robot service system of claim 2, wherein:
the server is further configured to:
store a lookup table comprising the plurality of face recognition models and corresponding feature information, wherein the feature information comprises, for each face recognition model of the plurality of face recognition models, at least one of a size, a throughput, memory usage, or performance; and
select the selected face recognition model further based on the feature information.

7. The robot service system of claim 1, wherein:
the plurality of face recognition models comprise artificial neural network-based models built via deep learning, and
at least one of the plurality of face recognition models is light-weighted based on pruning or quantization techniques during a training process.

8. The robot service system of claim 1, wherein:
the robot is further configured to, based on executing the face recognition function:
detect, based on an image of a face recognition target, facial feature information; and
verify, based on the facial feature information, an identity of the face recognition target.

9. The robot service system of claim 1, wherein:
the robot is further configured to:
detect, based on an image of a face recognition target, facial feature information;
transmit, to the server, the facial feature information; and
the server is further configured to:
store user information comprising facial feature information for a plurality of pre-registered users; and
verify, based on comparing the facial feature information received from the robot to the facial feature information of the plurality of pre-registered users, an identity of the face recognition target.

10. The robot service system of claim 9, wherein:
the robot is further configured to:
detect, based on the image, additional attribute information comprising at least one of age or gender; and
transmit, to the server, the additional attribute information; and
the server is further configured to:
select, based on the additional attribute information, a candidate group from the plurality of pre-registered users; and
verify the identity of the face recognition target by comparing the facial feature information received from the robot to a portion of the facial feature information corresponding to the candidate group.

11. The robot service system of claim 1, wherein:
the server is further configured to:
collect location information of the robot; and
manage, based on the location information, behavioral information of a user recognized via the face recognition function.

12. The robot service system of claim 1, wherein the robot is configured to, based on the identified user being an unregistered user, provide the service, wherein the service comprises at least one of:
a greeting service configured to guide the unregistered user, or
a surveillance service configured to surveil the unregistered user.

13. The robot service system of claim 1, wherein the robot is configured to, based on the identified user being a registered user, provide the service based on user information associated with the user.

14. A method comprising:
determining hardware environment information of a robot;
installing, on the robot, a face recognition model selected, based on the hardware environment information, from a plurality of face recognition models having different degrees of light-weighting;
executing, by using the selected face recognition model, a face recognition function;
performing, via the face recognition function, a user identification; and
providing, based on a result of the user identification, a service to a user.

15. The method of claim 14, further comprising:
transmitting the hardware environment information to a server comprising the plurality of face recognition models; and
receiving the selected face recognition model from the server.

16. The method of claim 15, wherein:
the hardware environment information comprises at least one of:
hardware specification information;
performance information; or
target performance information related to the face recognition function of the robot.

17. The method of claim 15, wherein:
the plurality of face recognition models comprise artificial neural network-based models built via deep learning, and
at least one of the plurality of face recognition models is light-weighted based on pruning or quantization techniques during a training process.

18. The method of claim 14, further comprising:
acquiring an image of a face recognition target; and
detecting, based on the image, facial feature information associated with the face recognition target, wherein:
the performing the user identification is based on the facial feature information associated with the face recognition target and user information associated with a plurality of pre-registered users.

19. The method of claim 18, wherein the user information comprises facial feature information associated with the plurality of pre-registered users, the method further comprising:
comparing the facial feature information associated with the face recognition target and the facial feature information associated with the plurality of pre-registered users; and
determining, based on the comparing satisfying a threshold, that a user, of the plurality of pre-registered users, is the face recognition target.

20. The method of claim 18, wherein the user information comprises facial feature information associated with the plurality of pre-registered users, the method further comprising:
comparing the facial feature information associated with the face recognition target and the facial feature information associated with the plurality of pre-registered users; and determining, based on the comparing not satisfying a threshold, that the face recognition target is an unregistered user.
